(19) United States
(12) Patent Application Publication
(10) Pub. No.: US 2015/0091536 A1
(43) Pub. Date: Apr. 2, 2015

(54) SEMICONDUCTOR DEVICE AND CONTROL METHOD THEREOF

(71) Applicant: Renesas Electronics Corporation, Kawasaki-shi (JP)

(72) Inventor: Hideaki Tanaka, Kawasaki-shi (JP)

(21) Appl. No.: 14/466,749

(22) Filed: Aug. 22, 2014

(30) Foreign Application Priority Data
Sep. 27, 2013 (JP) 2013-202002

(51) Int. Cl. H02M 3/158

(52) U.S. Cl. CPC H02M 3/158
USPC 323/235

(57) ABSTRACT

A semiconductor device includes: first and second switching elements connected in series through a switching node; a pulse control unit that pulse-controls switching operations of the first and the second switching elements; an inductor that outputs an output voltage from a second end, a first end of the inductor being coupled to the switching node; a detection unit that detects that an inductor current flowing through the inductor is zero; and a first determination unit that determines that an operation mode of an external circuit to which the output voltage is supplied is a second mode when a period during which the inductor current is zero is longer than a first reference period, a power consumption in the second mode being smaller than that in a first mode.

### CROSS-REFERENCE TO RELATED APPLICATIONS

This application is based upon and claims the benefit of priority from Japanese patent application No. 2013-202002, filed on Sep. 27, 2013, the disclosure of which is incorporated herein in its entirety by reference.

### BACKGROUND

The present invention relates to a semiconductor device and a control method thereof and, for example, to a semiconductor device such as a switching regulator and a control method thereof.

When a voltage-supplied device (a microcomputer, for example), to which a switching regulator supplies voltage, is in an ultralow power mode such as a so-called standby mode, the voltage-supplied device cannot issue a command indicating that it is in the ultralow power mode. Therefore, the switching regulator is expected to detect a power mode of the voltage-supplied device. Note that the ultralow power mode is a state where only, for example, a real-time clock and memories operate.

Japanese Unexamined Patent Application Publication No. 2002-44939 discloses a switching regulator capable of detecting a light load state of the voltage-supplied device by detecting a zero-crossing voltage.

### SUMMARY

The present inventor has found the following problem. In the switching regulator disclosed in Japanese Unexamined Patent Application Publication No. 2002-44939, it is impossible to detect a lighter load state such as the above-mentioned ultralow power mode.

The other problems and novel features of the present invention will become apparent from the description of the specification and the accompanying drawings.

According to one embodiment, a semiconductor device includes a determination unit that determines that an operation mode of an external circuit to which the output voltage is supplied is a second mode when a period that an inductor current is zero is longer than a first reference period, a power consumption in the second mode being smaller than that in a first mode.

According to one embodiment, it is possible to detect a lighter load state of the external circuit to which an output voltage of the semiconductor device is supplied.

### BRIEF DESCRIPTION OF THE DRAWINGS

The above and other aspects, advantages and features will be more apparent from the following description of certain embodiments thereof taken in conjunction with the accompanying drawings, in which:

FIG. 1 is a block diagram showing a semiconductor device according to a first embodiment;

FIG. 2 is a circuit diagram showing a semiconductor device according to the first embodiment;

FIG. 3 is a circuit diagram showing an example of a power mode determination unit PMD;

FIG. 4 is a timing chart for explaining an operation of the semiconductor device according to the first embodiment;

FIG. 5 is a block diagram showing a semiconductor device according to a second embodiment;

FIG. 6 is a circuit diagram showing an example of a first power mode determination unit PMD1;

FIG. 7 is a circuit diagram showing an example of a second power mode determination unit PMD2;

FIG. 8 is a timing chart for explaining an operation of the second power mode determination unit PMD2; and

FIG. 9 is a timing chart for explaining an operation of the semiconductor device according to the second embodiment.

### DETAILED DESCRIPTION

### First Embodiment

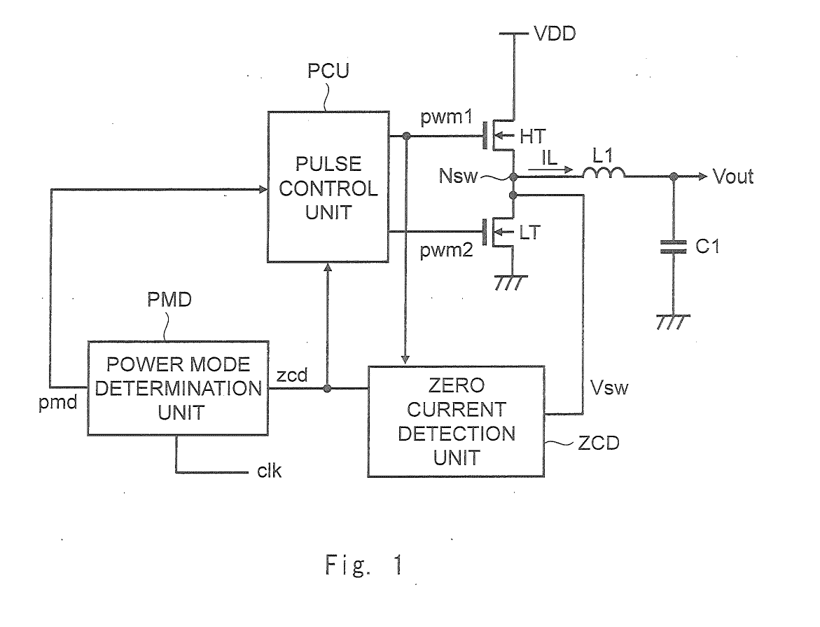

First, referring to FIG. 1, a semiconductor device according to a first embodiment will be described. FIG. 1 is a block diagram showing a semiconductor device according to a first embodiment. The semiconductor device according to the first embodiment is a switching regulator that includes a pulse control unit PCU, a high side transistor HT, a low side transistor LT, an output inductor L1, an output capacitor C1, a zero current detection unit ZCD, and a power mode determination unit PMD. The semiconductor device according to the first embodiment supplies an output voltage to, for example, a microcomputer that is an external circuit.

The pulse control unit PCU generates a PWM signal (pulse control signal) pwm1 that controls on-off (switching operation) of the high side transistor HT and a PWM signal pwm2 that controls on-off (switching operation) of the low side transistor LT.

The pulse control unit PCU also receives a zero current detection signal zcd output from the zero current detection unit ZCD. When the zero current detection signal zcd switches to H (High) level, the pulse control unit PCU turns off the low side transistor LT. This makes it possible to prevent an inductor current IL from flowing back to the ground and improve power efficiency.

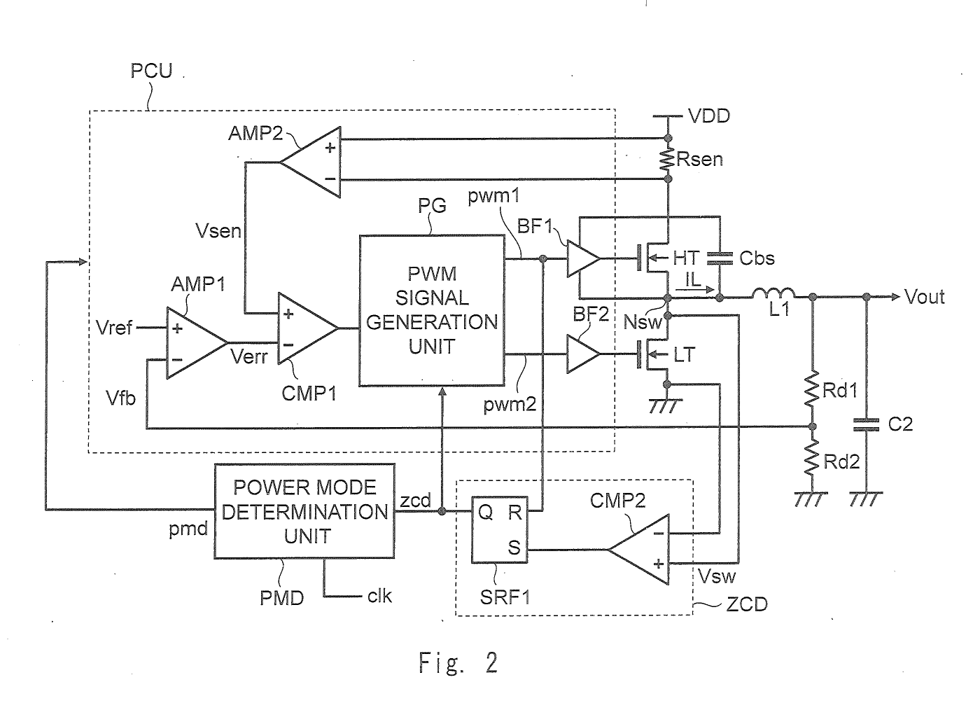

In addition, the pulse control unit PCU receives a power mode determination signal pmd. When the power mode determination signal pmd switches to H level and then the microcomputer is determined to be in an ultralow power mode, the pulse control unit PCU reduces its own power consumption. Note that the pulse control unit PCU will be described in detail later with reference to FIG. 2.

The high side transistor HT is a first switching element in the switching regulator. The high side transistor HT is composed of an NMOS transistor. The PWM signal pwm1 input to the gate controls on-off of the high side transistor HT. The drain of the high side transistor HT is coupled to the power supply (power-supply voltage VDD). The source of the high side transistor HT is coupled to the drain of the low side transistor LT. The high side transistor HT may also be composed of a PMOS transistor. In this case, the gate of the PMOS transistor receives the inverted signal of the PWM signal pwm1.

The low side transistor LT is a second switching element in the switching regulator. The low side transistor LT is composed of an NMOS transistor. The PWM signal pwm2 input to the gate controls on-off of the low side transistor LT. The source of the low side transistor LT is grounded. A connection node where the high side transistor HT and the low side transistor LT are connected in series is referred to as a switching node Nsw.

A first end of the output inductor L1 is coupled to the switching node Nsw. A second end of the output inductor L1 is an output of the semiconductor device. In other words, an output voltage Vout is output from the second end of the output inductor L1. The output capacitor C1 is provided between the second end of the output inductor L1 and the ground.

The zero current detection unit ZCD detects that a current flowing through the output inductor L1 (inductor current IL) is zero and outputs the zero current detection signal zcd. Specifically, the zero current detection unit ZCD detects a zero crossing of the voltage of the switching node Nsw (switching node voltage) Vsw. When the zero crossing of the switching node voltage Vsw occurs, the high side transistor HT is off and the low side transistor LT is on. In this case, when the switching node voltage Vsw becomes zero, the inductor current IL also becomes zero.

Note that the zero crossing of the switching node voltage Vsw occurs when the microcomputer is in a low power mode where power consumption is low to some extent or in the ultralow power mode where power consumption is lower. In other words, when the microcomputer is in an operation mode where power consumption is high, the zero crossing of the switching node voltage Vsw does not occur. Meanwhile, it is impossible to distinguish between the low power mode and the ultralow power mode only by detecting that the inductor current IL is zero.

When the zero crossing of the switching node voltage Vsw is detected, the zero current detection signal zcd switches to H level. As described above, the zero current detection signal zcd is input to the pulse control unit PCU. When the zero current detection signal zcd switches to H level, the pulse control unit PCU turns off the low side transistor LT. Thus, the state where the inductor current IL is zero is maintained.

On the other hand, the zero current detection unit ZCD receives the PWM signal pwm1 that controls on-off of the high side transistor HT. When the PWM signal pwm1 switches from L (Low) level to H level, the zero current detection signal zcd switches to L level. In other words, when the high side transistor HT turns on and then the inductor current IL is no longer zero, the zero current detection signal zcd switches to L level. In this manner, while the inductor current IL is zero, the zero current detection unit ZCD maintains the zero current detection signal zcd at H level. Note that the zero current detection unit ZCD will be described in detail later with reference to FIG. 2.

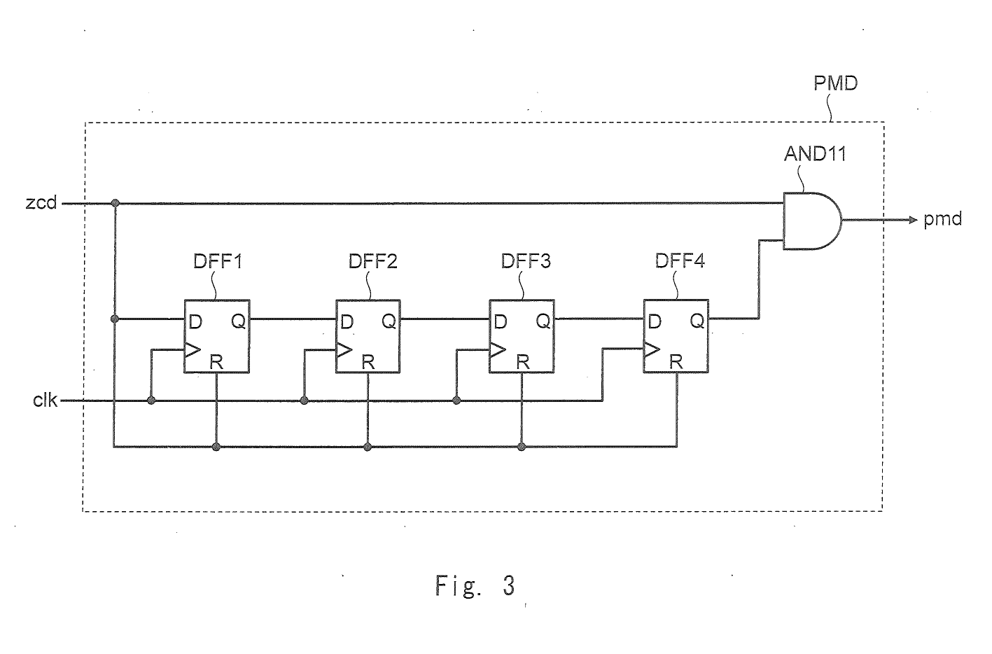

The power mode determination unit PMD measures a period during which the input zero current detection signal zcd is H level (a period during which the inductor current IL is zero) and then outputs the power mode determination signal pmd. Specifically, when the period during which the inductor current IL is zero exceeds a predetermined length, the power mode determination unit PMD determines that the microcomputer is in the ultralow power mode and switches the power mode determination signal pmd to H level. Note that the power mode determination unit PMD will be described in detail later with reference to FIG. 3.

The semiconductor device according to the first embodiment includes the power mode determination unit PMD that determines a power mode of the voltage-supplied device by measuring the period during which the inductor current IL is zero in addition to the zero current detection unit ZCD that detects that the inductor current IL is zero. Therefore, in the semiconductor device according to the first embodiment, it is possible to determine the ultralow power mode which cannot be determined only by detecting that the inductor current IL is zero. In addition, since the ultralow power mode of the voltage-supplied device can be determined, the semiconductor device itself can be set to the ultralow power mode. As a result, the power consumption of the semiconductor device can be reduced.

Next, referring to FIG. 2, details of the semiconductor device according to the first embodiment will be described. FIG. 2 is a circuit diagram showing a semiconductor device according to the first embodiment. As shown in FIG. 2, the pulse control unit PCU shown in FIG. 1 includes an error amplifier AMP1, a PWM comparator CMP1, a PWM signal generation unit PG, buffers BF1 and BF2, and a current detection amplifier AMP2. The zero current detection unit ZCD shown in FIG. 1 includes a comparator CMP2 and an SR flip-flop SRF1. Further, the semiconductor device according to the first embodiment includes a current detection resistor Rsen, a bootstrap capacitor Cbs, and voltage dividing resistors Rd1 and Rd2 which are omitted in FIG. 1.

First, a configuration of the pulse control unit PCU will be described. The current detection resistor Rsen, the bootstrap capacitor Cbs, and the voltage dividing resistors Rd1 and Rd2 will also be described.

The error amplifier AMP1 includes a non-inverting input terminal and an inverting input terminal. A reference voltage Vref is input to the non-inverting input terminal. A feedback voltage Vfb fed back from the output of the semiconductor device is input to the inverting input terminal. The feedback voltage Vfb is generated by dividing the output voltage Vout with the voltage dividing resistors Rd1 and Rd2.

As shown in FIG. 2, a first end of the voltage dividing resistor Rd1 is coupled to a second end of the output inductor L1, or to the output of the semiconductor device. A second end of the voltage dividing resistor Rd1 is coupled to a first end of the voltage dividing resistor Rd2. A second end of the voltage dividing resistor Rd2 is grounded. In other words, the voltage dividing resistors Rd1 and Rd2 are connected in series between the output of the semiconductor device and the ground. The feedback voltage Vfb is a voltage at the connection node of the voltage dividing resistor Rd1 and the voltage dividing resistor Rd2. Thus, the feedback voltage Vfbi is expressed as the following equation.

Vfb=Vout×Rd2/(Rd1+Rd2)

In the pulse control unit PCU, a non-inverting input voltage (reference voltage Vref) and an inverting input voltage (feedback voltage Vfb) of the error amplifier AMP1 are PWM-controlled to be equal each other.

Therefore, the output voltage Vout of the semiconductor device can be expressed as the following equation. This output voltage Vout becomes a target voltage Vtg.

Vout=Vref×(Rd1+Rd2)/Rd2

A first end of the current detection resistor Rsen is coupled to the drain of the high side transistor HT. A second end of the current detection resistor Rsen is coupled to the power supply (power-supply voltage VDD). In other words, the current detection resistor Rsen is provided between the drain of the high side transistor HT and the power supply (power-supply voltage VDD). The current detection resistor Rsen detects the drain current of the high side transistor HT.

The first end of the current detection resistor Rsen is coupled to the inverting input terminal of the current detection amplifier AMP2. The second end of the current detection resistor Rsen is coupled to the non-inverting input terminal of the current detection amplifier AMP2. The current detection amplifier AMP2 amplifies a voltage between both ends of the current detection resistor Rsen and then outputs a detection voltage Vsen. In other words, the current detection amplifier AMP2 converts the drain current of the high side transistor HT detected by the current detection resistor Rsen into a voltage.

The PWM comparator CMP1 generates the PWM signals pwm1 and pwm2 that control on-off of the high side transistor HT and the low side transistor LT. Ann error voltage Verr output from the error amplifier AMP1 is input to the inverting input terminal of the PWM comparator CMP1. The detection voltage Vsen output from the current detection amplifier AMP2 is input to the non-inverting input terminal of the PWM comparator CMP1. The PWM comparator CMP1 compares the detection voltage Vsen with the error voltage Verr. Specifically, when the detection voltage Vsen is larger than the error voltage Verr, the PWM comparator CMP1 outputs H level. When the detection voltage Vsen is smaller than the error voltage Verr, the PWM comparator CMP1 outputs L level.

According to the signal input from the PWM comparator CMP1, the PWM signal generation unit PG generates the PWM signals pwm1 and pwm2. The PWM signal pwm1 is input to the gate of the high side transistor HT through the buffer BF1. On-off of the high side transistor HT is controlled according to the PWM signal pwm1. On the other hand, the PWM signal pwm2 is input to the gate of the low side transistor LT through the buffer BF2. On-off of the low side transistor LT is controlled according to the PWM signal pwm2.

In order to turn on the high side transistor HT composed of an NMOS transistor, it is necessary to apply a control voltage higher than the power-supply voltage VDD to the gate of the high side transistor HT. Therefore, the bootstrap capacitor Cbs for boosting voltage is coupled to the buffer BF1 that outputs the control voltage to the high side transistor HT. Note that when the high side transistor HT is composed of a PMOS transistor, the bootstrap capacitor Cbs is not necessary.

While the PWM comparator CMP1 outputs H level, the PWM signal generation unit PG brings the PWM signal pwm1 into L level and the PWM signal pwm2 into H level. In other words, while the detection voltage Vsen is larger than the error voltage Verr, the high side transistor HT is off and the low side transistor LT is on. On the other hand, while the PWM comparator CMP1 outputs L level, the PWM signal generation unit PG brings the PWM signal pwm1 into H level and the PWM signal pwm2 into L level. In other words, while the detection voltage Vsen is smaller than the error voltage Verr, the high side transistor HT is on and the low side transistor LT is off.

In addition, the zero current detection signal zcd output from the zero current detection unit ZCD is input to the PWM signal generation unit PG. When the zero current detection signal zcd switches to H level, the PWM signal generation unit PG forcibly switches the PWM signal pwm2 to L level to turn off the low side transistor LT. This makes it possible to prevent an inductor current IL from flowing back to the ground and improve power efficiency. In this case, since the PWM signal pwm1 is maintained at L level, the high side transistor HT is maintained off. Therefore, the inductor current IL is maintained at zero.

Next, a configuration of the zero current detection unit ZCD will be described. The comparator CMP2 detects the zero crossing of the switching node voltage Vsw. The inverting input terminal of the comparator CMP2 is grounded. The switching node voltage Vsw is input to the non-inverting input terminal of the comparator CMP2. When the switching node voltage Vsw is larger than 0V, the comparator CMP2 outputs H level. On the other hand, when the switching node voltage Vsw is smaller than 0V, the comparator CMP2 outputs L level. In short, the comparator CMP2 determines whether the switching node voltage Vsw is positive or negative. Here, the zero crossing of the switching node voltage Vsw is that where the switching node voltage Vsw changes from negative to positive. Therefore, the zero crossing is detected at the timing when the output of the comparator CMP2 switches from L level to H level.

The SR flip-flop SRF1 is a latch circuit to detect the zero crossing of the switching node voltage Vsw. The output signal of the comparator CMP2 is input to the set input terminal S of the SR flip-flop SRF1. The PWM signal pwm1 that controls on-off of the high side transistor HT is input to the reset input terminal R of the SR flip-flop SRF1. The zero current detection signal zcd is output from the output terminal Q of the SR flip-flop SRF1.

Therefore, at the timing when the comparator CMP2 detects the zero crossing and the output of the comparator CMP2 switches from L level to H level, the zero current detection signal zcd switches from L level to H level. On the other hand, at the timing when the PWM signal pwm1 switches from L level to H level and the high side transistor HT turns on, the zero current detection signal zcd switches from H level to L level.

As described above, at the timing when the zero crossing of the switching node voltage Vsw occurs, the inductor current IL becomes zero. Then, when the zero current detection signal zcd switches from L level to H level by the zero crossing, the low side transistor LT forcibly turns off, and the inductor current IL is maintained at zero. On the other hand, at the timing when the high side transistor HT turns on and the inductor current IL no longer becomes zero, the zero current detection signal zcd switches to L level. In this manner, while the inductor current IL is zero, the zero current detection unit ZCD maintains the zero current detection signal zcd at H level.

Next, referring to FIG. 3, a configuration of the power mode determination unit PMD will be described. FIG. 3 is a circuit diagram showing an example of a power mode determination unit PMD. As shown in FIG. 3, the power mode determination unit PMD includes D flip-flops DFF1 to DFF4 and AND gate AND11.

A clock signal clk is input to a clock input terminal of the D flip-flops DFF1 to DFF4. The zero current detection signal zcd is input to the reset input terminal R of the D flip-flops DFF1 to DFF4. The D flip-flops DFF1 to DFF4 are asynchronous flip-flops. While the zero current detection signal zcd is L level, the D flip-flops DFF1 to DFF4 are in the reset state and an L level signal is output from each output terminal Q. When the zero current detection signal zcd switches from L level to H level, the reset state of the D flip-flops DFF1 to DFF4 is released.

The zero current detection signal zcd is input to the D input terminal of the D flip-flop DFF1. When the zero current detection signal zcd switches from L level to H level, the output signal of the D flip-flop DFF1 switches from L level to H level at the next (first) rising edge of the clock signal clk.

The output signal of the D flip-flop DFF1 is input to the D input terminal of the D flip-flop DFF2. When the output signal of the D flip-flop DFF1 switches from L level to H level, the output signal of the D flip-flop DFF2 switches from L level to H level at the next (second) rising edge of the clock signal clk.

The output signal of the D flip-flop DFF2 is input to the D input terminal of the D flip-flop DFF3. When the output signal of the D flip-flop DFF2 switches from L level to H level, the output signal of the D flip-flop DFF3 switches from L level to H level at the next (third) rising edge of the clock signal clk.

The output signal of the D flip-flop DFF3 is input to the D input terminal of the D flip-flop DFF4. When the output signal of the D flip-flop DFF3 switches from L level to H level, the output signal of the D flip-flop DFF4 switches from L level to H level at the next (fourth) rising edge of the clock signal clk.

The zero current detection signal zcd and the output signal of the D flip-flop DFF4 are input to the AND gate AND11. The AND gate AND11 outputs the power mode determination signal pmd. At the fourth rising edge of the clock signal clk after the zero current detection signal zcd has risen, the power mode determination unit PMD shown in FIG. 3 switches the power mode determination signal pmd from L level to H level. In this manner, when the period during which the input zero current detection signal zcd is H level (the period during which the inductor current IL is zero) exceeds a predetermined length, the power mode determination unit PMD determines that the microcomputer is in the ultralow power mode and switches the power mode determination signal pmd to H level. Note that the circuit configuration of the power mode determination unit PMD shown in FIG. 3 is only an example. Further, the number of D flip-flops shown in FIG. 3 can be appropriately determined according to a detection time Tdet.

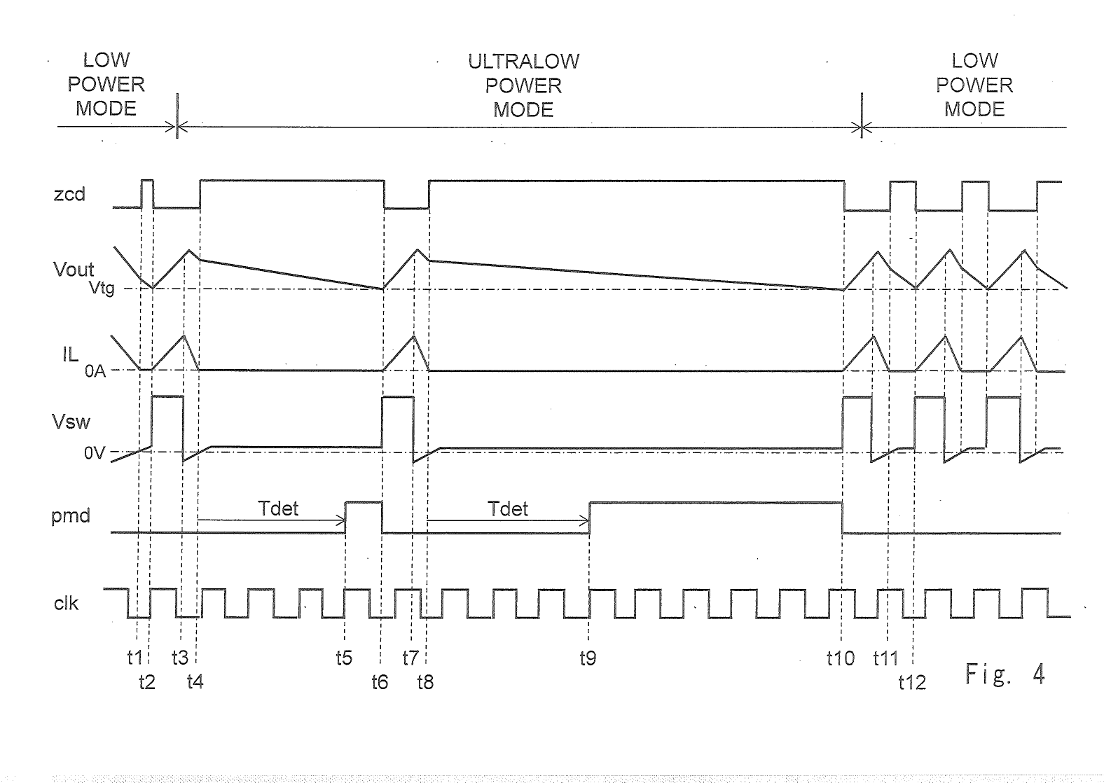

Next, referring to FIG. 4, an operation of the semiconductor device according to the first embodiment will be described. FIG. 4 is a timing chart for explaining an operation of the semiconductor device according to the first embodiment.

From the top to the bottom in FIG. 4, the zero current detection signal zcd, the output voltage Vout, the inductor current IL, the switching node voltage Vsw, the power mode determination signal pmd, and the clock signal clk are shown.

At time t1, when the zero crossing (crossing with 0V) of the switching node voltage Vsw occurs from negative to positive, the zero current detection signal zcd switches from L level to H level. At the same timing, the inductor current IL becomes zero (0 A). Further, at the same timing, the low side transistor LT turns off. Therefore, both the high side transistor HT and the low side transistor LT are off.

Between time t1 and t2, the zero current detection signal zcd is maintained at H level. During this period, both the high side transistor HT and the low side transistor LT are maintained off. Therefore, the output voltage Vout gradually falls according to current consumption by the microcomputer. The inductor current IL is maintained at zero. The value of the switching node voltage Vsw is also maintained.

At time t2, when the output voltage Vout reaches the target voltage Vtg, the high side transistor HT turns on. Therefore, the zero current detection signal zcd switches from H level to L level. As a result, the switching node voltage Vsw rises to the power-supply voltage VDD.

Between time t2 and t3, the high side transistor HT is maintained on and the low side transistor LT is maintained off. Therefore, the output voltage Vout and the inductor current IL continue to rise.

At time t3, the high side transistor HT turns off and the low side transistor LT turns on. As a result, the switching node voltage Vsw falls to a voltage lower than 0V.

Between time t3 and t4, the high side transistor HT is maintained off and the low side transistor LT is maintained on. Therefore, during this period, the inductor current IL continues to fall. The output voltage Vout begins to fall later than the inductor current IL. On the other hand, the switching node voltage Vsw continues to rise gradually.

At time t4, when the zero crossing of the switching node voltage Vsw occurs from negative to positive, the zero current detection signal zcd switches from L level to H level. At the same timing, the inductor current IL becomes zero. Further, at the same timing, the low side transistor LT turns off. Therefore, both the high side transistor HT and the low side transistor LT are off.

Between time t4 and t6, the zero current detection signal zcd is maintained at H level. During this period, both the high side transistor HT and the low side transistor LT are maintained off. Therefore, the output voltage Vout gradually falls according to current consumption by the microcomputer. Meanwhile, between time t2 and t3, the microcomputer changes from the low power mode to the ultralow power mode. Therefore, current consumption by the microcomputer decreases and the gradient of the dropping of the output voltage Vout is gentler than that between time t1 and time t2. During this period, the inductor current IL is maintained at zero. The value of the switching node voltage Vsw is also maintained

Between time t4 and time t6, at time t5 when the predetermined detection time Tdet elapses from the rising edge of the zero current detection signal zcd (time t4), the power mode determination signal pmd switches from L level to H level. In other words, the power mode determination unit PMD determines that the microcomputer is in the ultralow power mode. As shown in FIG. 4, in the ultralow power mode, the period during which the zero current detection signal zcd is maintained at H level becomes long. Therefore, it is possible to determine the ultralow power mode by measuring the period. Note that, in the example shown in FIG. 4, the detection time Tdet is the period from the rising edge of the zero current detection signal zcd to the fourth rising edge of the clock signal clk.

At time t6, when the output voltage Vout reaches the target voltage Vtg, the high side transistor HT turns on. Therefore, the zero current detection signal zcd switches from H level to L level. As a result, the power mode determination signal pmd switches from H level to L level. Thus, the determination of the ultralow power mode is released. Further, the switching node voltage Vsw rises to the power-supply voltage VDD.

At time t7, the high side transistor HT turns off and the low side transistor LT turns on. As a result, the switching node voltage Vsw falls to a voltage lower than 0V.

Between time t7 and t8, the high side transistor HT is maintained off and the low side transistor LT is maintained on. Therefore, during this period, the inductor current IL continues to fall. The output voltage Vout begins to fall later than the inductor current IL. On the other hand, the switching node voltage Vsw continues to rise gradually.

At time t8, when the zero crossing of the switching node voltage Vsw occurs from negative to positive, the zero current detection signal zcd switches from L level to H level. At the same timing, the inductor current IL becomes zero. Further, at the same timing, the low side transistor LT turns off. Therefore, both the high side transistor HT and the low side transistor LT are off.

Between time t8 and t10, the zero current detection signal zcd is maintained at H level. During this period, both the high side transistor HT and the low side transistor LT are maintained off. Therefore, the output voltage Vout gradually falls according to current consumption by the microcomputer. The microcomputer is maintained in the ultralow power mode. Therefore, the gradient of the dropping of the output voltage Vout is gentler than that between time t1 and time t2. During this period, the inductor current IL is maintained at zero. The value of the switching node voltage Vsw is also maintained.

Between time t8 and time t10, at time t9 when the predetermined detection time Tdet elapses from the rising edge of the zero current detection signal zcd (time t8), the power mode determination signal pmd switches from L level to H level. In other words, the power mode determination unit PMD determines that the microcomputer is in the ultralow power mode.

At time t10, when the output voltage Vout reaches the target voltage Vtg, the high side transistor HT turns on. Therefore, the zero current detection signal zcd switches from H level to L level. As a result, the power mode determination signal pmd switches from H level to L level. Thus, the determination of the ultralow power mode is released.

Next, between time t11 and time t12, in a manner similar to that of the operation between time t4 and time t6 or the like described above, the zero current detection signal zcd is maintained at H level. Meanwhile, between time t10 and time t11, the microcomputer changes from the ultralow power mode to the low power mode. Therefore, between time t11 and time t12, the period during which the zero current detection signal zcd is maintained at H level becomes short and the power mode determination signal pmd does not switch from L level to H level. Therefore, the power mode determination unit PMD determines that the microcomputer is no longer in the ultralow power mode but instead in the low power mode now.

As described above, the semiconductor device according to the first embodiment includes the power mode determination unit PMD that determines a power mode of the voltage-supplied device to which the semiconductor device supplies voltage by measuring the period during which the inductor current IL is zero in addition to the zero current detection unit ZCD that detects that the inductor current IL is zero. Therefore, in the semiconductor device according to the first embodiment, it is possible to determine the ultralow power mode which cannot be determined only by detecting that the inductor current IL is zero.

### Second Embodiment

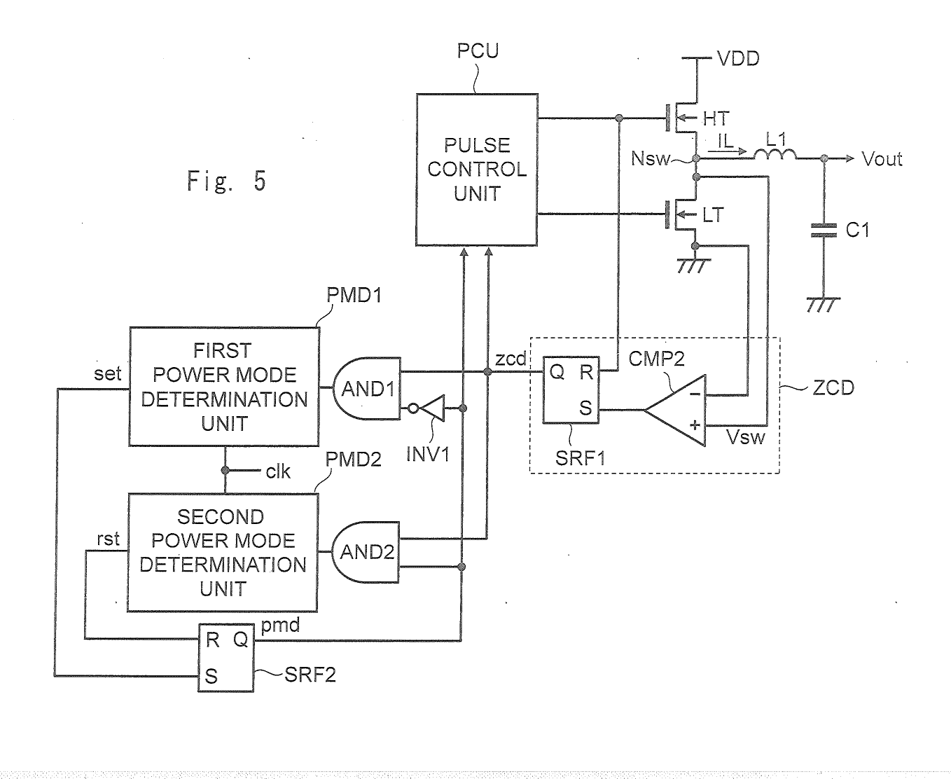

Next, referring to FIG. 5, a semiconductor device according to a second embodiment will be described. FIG. 5 is a block diagram showing a semiconductor device according to a second embodiment. The semiconductor device according to the second embodiment includes, instead of the power mode determination unit PMD in the semiconductor device according to the first embodiment, a first power mode determination unit PMD1, a second power mode determination unit PMD2, AND gates AND1 and AND2, an inverter INV1, and a SR flip-flop SRF2. The other components are similar to those of the semiconductor device according to the first embodiment, so the description thereof is omitted.

The zero current detection signal zcd and the inverted signal of the power mode determination signal pmd output from the output terminal Q of the SR flip-flop SRF2 are input to the AND gate AND1. Here, the power mode determination signal pmd is inverted by the inverter INV1 and then input to the AND gate AND1. The output signal of the AND gate AND1 is input to the first power mode determination unit PMD1.

The first power mode determination unit PMD1, in a manner similar to that of the power mode determination unit PMD according to the first embodiment, measures a period during which the input zero current detection signal zcd is H level (a period during which the inductor current IL is zero) and then outputs a set signal set. Specifically, when the period during which the inductor current IL is zero exceeds a predetermined length, the first power mode determination unit PMD1 determines that the microcomputer changes from the low power mode to the ultralow power mode and switches the set signal set to H level.

The zero current detection signal zcd is not input directly to the first power mode determination unit PMD1, and instead the output signal of the AND gate AND1 is input thereto. As described above, the zero current detection signal zcd and the inverted signal of the power mode determination signal pmd are input to the AND gate AND1. Thus, the first power mode determination unit PMD1 operates when the power mode determination signal pmd is L level and does not operate when the power mode determination signal pmd is H level.

The zero current detection signal zcd and the power mode determination signal pmd output from the output terminal Q of the SR flip-flop SRF2 are input to the AND gate AND2. The output signal of the AND gate AND2 is input to the second power mode determination unit PMD2.

The second power mode determination unit PMD2 measures the frequency of rising edges of the zero current detection signal zcd in a predetermined period (release period) and then outputs a reset signal rst. Specifically, when the zero current detection signal zcd rises again within the release period, the second power mode determination unit PMD2 determines that the microcomputer changes from the ultralow power mode to the low power mode and switches the reset signal rst to H level.

The zero current detection signal zcd is not input directly to the second power mode determination unit PMD2, and instead the output signal of the AND gate AND2 is input thereto. As described above, the zero current detection signal zcd and the power mode determination signal pmd are input to the AND gate AND2. Thus, the second power mode determination unit PMD2 operates when the power mode determination signal pmd is H level and does not operate when the power mode determination signal pmd is L level.

The set signal set output from the first power mode determination unit PMD1 is input to the set input terminal S of the SR flip-flop SRF2. The reset signal rst output from the second power mode determination unit PMD2 is input to the reset input terminal R of the SR flip-flop SRF2. The power mode determination signal pmd is output from the output terminal Q of the SR flip-flop SRF1.

Therefore, when the period during which the inductor current IL is zero exceeds a predetermined length and the set signal set switches to H level, the power mode determination signal pmd also switches to H level. On the other hand, when the zero current detection signal zcd rises again and the reset signal rst switches to H level within the predetermined period starting from the rising of the zero current detection signal zcd, the power mode determination signal pmd switches to L level.

In the semiconductor device according to the first embodiment, each time the zero current detection signal zcd falls, the ultralow power mode of the semiconductor device itself is released even though the microcomputer is in the ultralow power mode. In the semiconductor device according to the second embodiment, while the microcomputer is in the ultralow power mode, the semiconductor device itself can maintain the ultralow power mode. Therefore, it is possible to reduce power consumption of the semiconductor device.

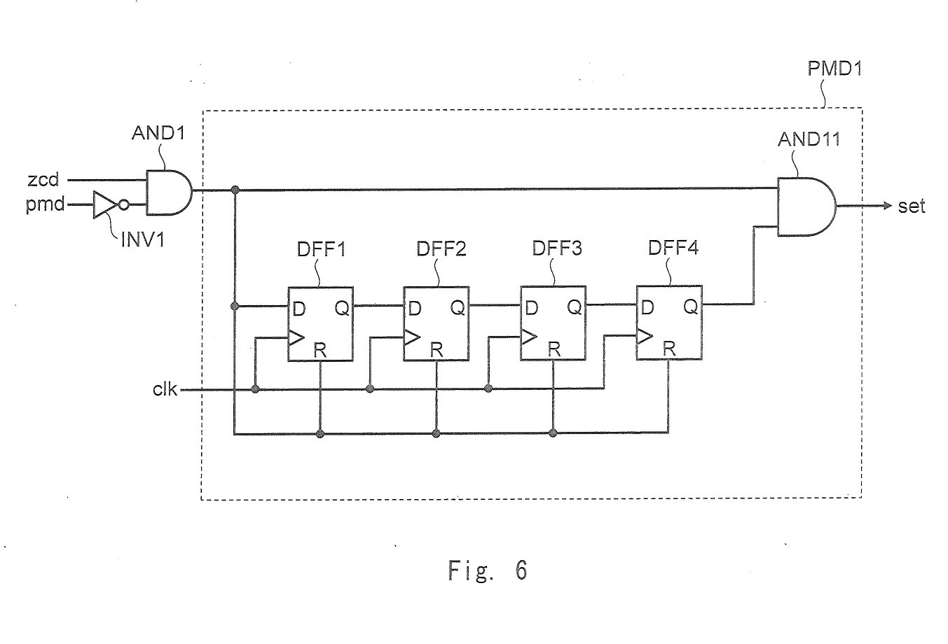

Next, referring to FIG. 6, a configuration of the first power mode determination unit PMD1 will be described. FIG. 6 is a circuit diagram showing an example of a first power mode determination unit PMD1. The circuit configuration of the first power mode determination unit PMD1 is similar to that of the power mode determination unit PMD according to the first embodiment shown in FIG. 3, so the description thereof is omitted. As shown in FIG. 6, unlike in the first embodiment shown in FIG. 3, the output signal of the AND gate AND1 is input to the first power mode determination unit PMD1. Further, the set signal set, rather than the power mode determination signal pmd as in the first embodiment shown in FIG. 3, is output from the AND gate AND11 of the first power mode determination unit PMD1.

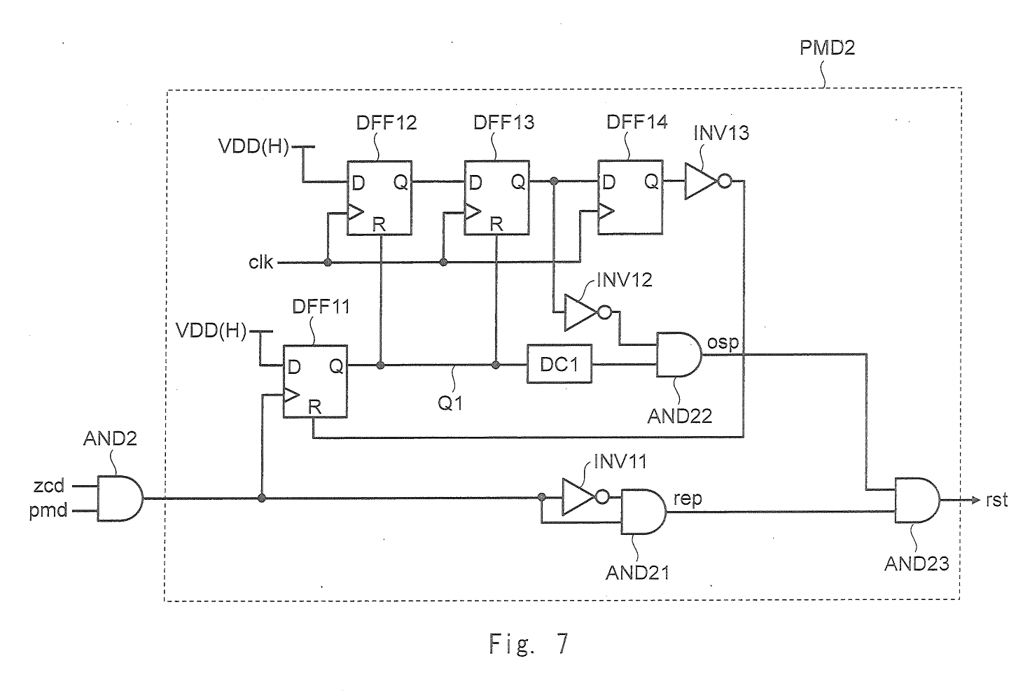

Next, referring to FIG. 7, a configuration of the second power mode determination unit PMD2 will be described. FIG. 7 is a circuit diagram showing an example of a second power mode determination unit PMD2. As shown in FIG. 7, the second power mode determination unit PMD2 includes D flip-flops DFF11 to DFF14, AND gates AND21 to AND23, inverters INV11 to INV13, and a delay circuit DC1. Cases will be described below where the power mode determination signal pmd is H level.

The D flip-flops DFF11 to DFF13 are asynchronous flip-flops. While the reset input signal is L level, the flip-flops DFF11 to DFF13 are in the reset state and an L level signal is output from each output terminal Q. When the reset input signal switches from L level to H level, the reset state of the D flip-flops DFF11 to DFF13 is released.

The output signal of the AND gate AND2 is input to the clock input terminal of the D flip-flop DFF11. The power-supply voltage VDD is input to the D input terminal of the D flip-flop DFF11. The inverted signal of the output signal of the D flip-flop DFF14 is input to the reset input terminal R of the D flip-flop DFF11. Here, the output signal of the D flip-flop DFF14 is inverted by the inverter INV13. Therefore, when the reset input signal is H level, the D flip-flop DFF11 outputs H level as the output signal Q1 at the rising edge of the zero current detection signal zcd.

The clock signal clk is input to the clock input terminal of the D flip-flop DFF12. The power-supply voltage VDD is input to the D input terminal of the D flip-flop DFF12. The output signal Q1 of the D flip-flop DFF11 is input to the reset input terminal R of the D flip-flop DFF12. Therefore, at the first rising edge of the clock signal clk after the output signal Q1 of the D flip-flop DFF11 switches from L level to H level, the output signal of the D flip-flop DFF12 switches from L level to H level.

The clock signal clk is input to the clock input terminal of the D flip-flop DFF13. The output signal of the D flip-flop DFF12 is input to the D input terminal of the D flip-flop DFF13. The output signal Q1 of the D flip-flop DFF11 is input to the reset input terminal R of the D flip-flop DFF13. Therefore, at the second rising edge of the clock signal clk after the output signal Q1 of the D flip-flop DFF11 switches from L level to H level, the output signal of the D flip-flop DFF13 switches from L level to H level.

The clock signal clk is input to the clock input terminal of the D flip-flop DFF14. The output signal of the D flip-flop DFF13 is input to the D input terminal of the D flip-flop DFF14. Therefore, at the third rising edge of the clock signal clk after the output signal Q1 of D flip-flop DFF11 switches from L level to H level, the output signal of the D flip-flop DFF14 switches from L level to H level.

As described above, the inverted signal of the output signal of the D flip-flop DFF14 is input to the reset input terminal R of the D flip-flop DFF11. Therefore, at the third rising edge of the clock signal clk after the output signal Q1 of the D flip-flop DFF11 switches from L level to H level, the D flip-flop DFF11 changes to the reset state and the output signal Q1 switches from H level to L level.

Further, at the same timing, the D flip-flops DFF12 and DFF13 also change to the reset state, and the output signals of them switch from H level to L level. Therefore, at the next rising edge of the clock signal clk, the output signal of the D flip-flop DFF14 switches from H level to L level. As a result, the reset signal of the D flip-flop DFF11 switches from L level to H level, and the reset state of the D flip-flop DFF11 is released. In this manner, at the next rising edge of the clock signal clk after the D flip-flop DFF11 switches to the reset state, its reset state is released.

A signal generated by delaying the output signal Q1 of the D flip-flop DFF11 by the delay amount dl by the delay circuit DC1 is input to the AND gate AND22. As described above, at the third rising edge of the clock signal clk after the output signal Q1 of the D flip-flop DFF11 rises, it falls.

Further, the inverted signal of the output signal of the D flip-flop DFF13 is input to the AND gate AND22. The output signal of the D flip-flop DFF13 is inverted by the inverter INV12. The output signal of the D flip-flop DFF13 is L level unless the output signal Q1 of the D flip-flop DFF11 rises. In addition, as described above, at the second rising edge of the clock signal clk after the output signal Q1 of the D flip-flop DFF11 rises, the output signal of the D flip-flop DFF13 rises. Therefore, the inverted signal of the output signal of the D flip-flop DFF13 falls at the second rising edge of the clock signal clk after the output signal Q1 of the D flip-flop DFF11 rises.

A one shot pulse osp is output from the AND gate AND22. The one shot pulse osp is a period signal that rises with the amount of delay dl after the output signal Q1 of the D flip-flop DFF11 rises (after the zero current detection signal zcd rises) and then falls at the second rising edge of the clock signal clk.

The output signal of the AND gate AND2 and its inverted signal are input to the AND gate AND21. Here, the output signal of the AND gate AND2 is inverted by the inverter INV11 with a certain amount of delay. The amount of delay of the inverter INV11 is a pulse width of a rising edge pulse rep. Thus, the amount of delay of the inverter INV11 is set to be smaller than the amount of delay dl by the delay circuit DC1. The rising edge pulse rep is output from the AND gate AND21. The rising edge pulse rep is a pulse signal that is output at the rising edge of the zero current detection signal zcd.

The one shot pulse osp and the rising edge pulse rep are input to the AND gate AND23. The AND gate AND23 outputs the reset signal rst. Therefore, when the zero current detection signal zcd rises again within the period from the rising of the zero current detection signal zcd to the second rising edge of the clock signal clk, the reset signal rst switches to H level.

Note that the circuit configuration of the second power mode determination unit PMD2 shown in FIG. 7 is only an example. Further, the number of D flip-flops shown in FIG. 7 can be appropriately determined according to a release time Trel.

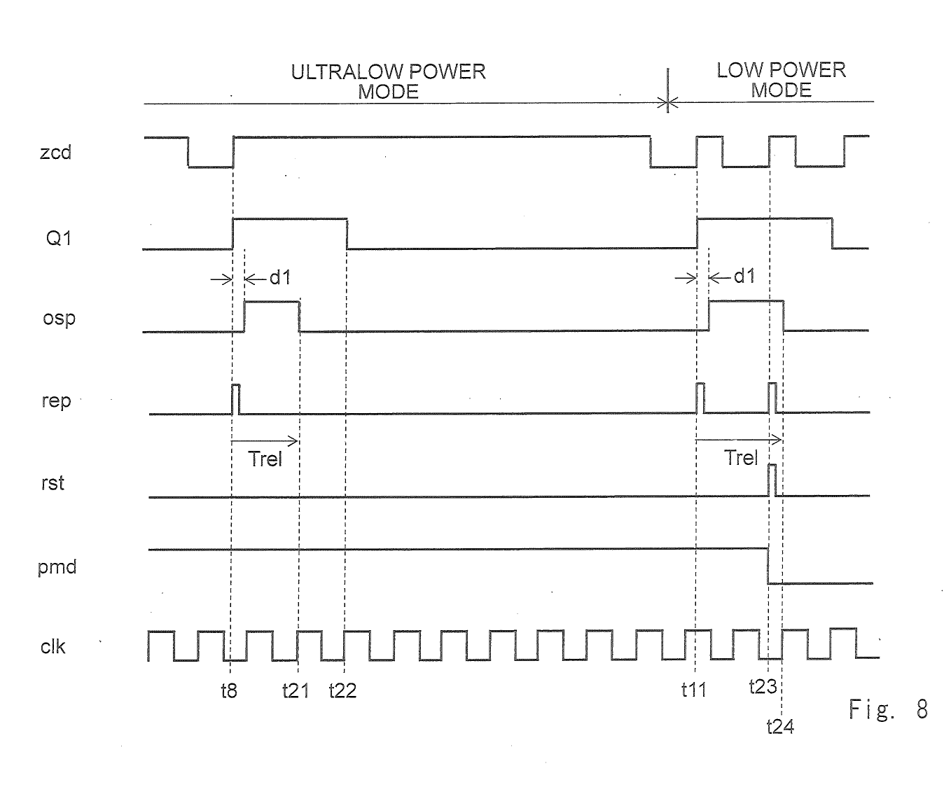

Next, referring to FIG. 8, an operation of the second power mode determination unit PMD2 will be described. FIG. 8 is a timing chart for explaining an operation of the second power mode determination unit PMD2.

From the top to the bottom in FIG. 8, the zero current detection signal zcd, the output signal Q1 of the D flip-flop DFF11, the one shot pulse osp, the rising edge pulse rep, the reset signal rst, the power mode determination signal pmd, and the clock signal clk are shown.

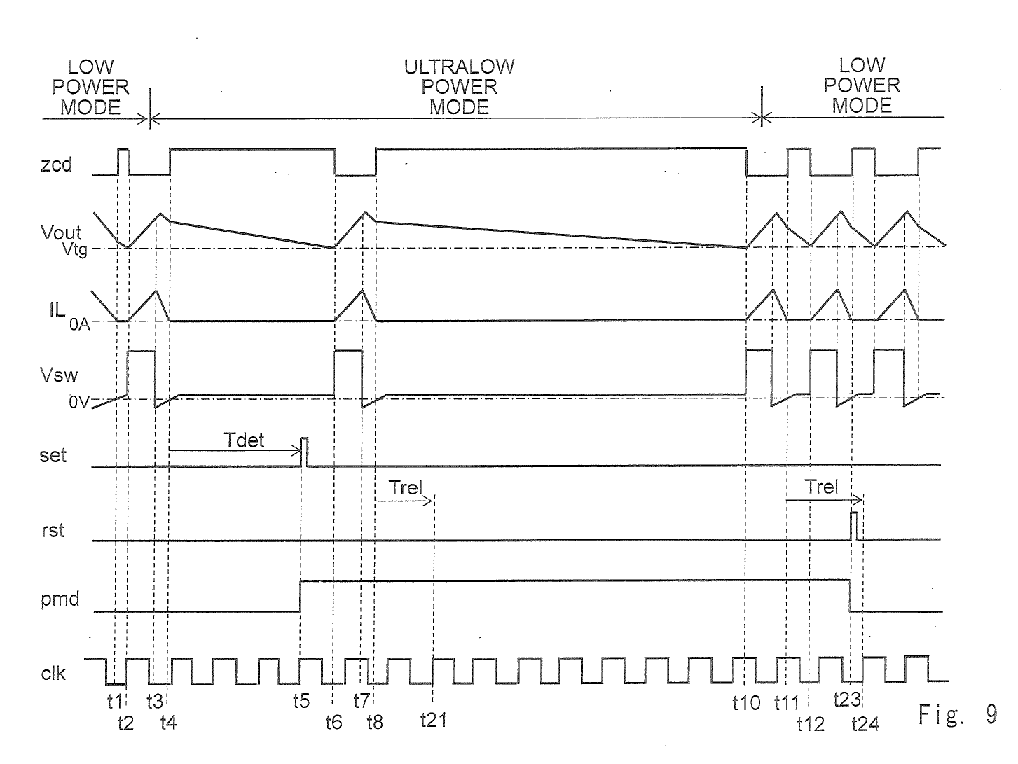

In FIG. 8, time indicated by the same sign in FIGS. 4 and 9 is identical with that in FIGS. 4 and 9.

At time t8, when the zero current detection signal zcd rises, the output signal Q1 of the D flip-flop DFF11 rises. Further, the rising edge pulse rep occurs. The one shot pulse osp rises with the amount of delay dl by the delay circuit DC1 from time t8.

At time t21, the one shot pulse osp falls. As described above, the one shot pulse osp falls at the second rising edge of the clock signal clk after the zero current detection signal zcd rises. As shown in FIG. 8, the release time Trel is the period from the rising edge (time t8) of the zero current detection signal zcd to the second rising edge (time t21) of the clock signal clk. Since no rising edge pulse rep occurs within the period during which the one shot pulse osp is H level, no reset signal rst occurs.

At time t22, the output signal Q1 of the D flip-flop DFF11 falls. As described above, at the third rising edge of the clock signal clk after the output signal Q1 of the D flip-flop DFF11 rises, it falls.

At time t11, when the zero current detection signal zcd rises, the output signal Q1 of the D flip-flop DFF11 rises. Further, the rising edge pulse rep occurs. The one shot pulse osp rises with the amount of delay dl by the delay circuit DC1 from time t11.

At time t24, the one shot pulse osp falls. As described above, the one shot pulse osp falls at the second rising edge of the clock signal clk after the zero current detection signal zcd rises. As shown in FIG. 8, the release time Trel is the period from the rising edge (time t11) of the zero current detection signal zcd to the second rising edge (time t24) of the clock signal clk.

Here, before time t11, the microcomputer changes from the ultralow power mode to the low power mode. Therefore, the period during which the zero current detection signal zcd is H level is short and the frequency of its rising increases. In the example shown in FIG. 8, at time t23 in the period during which the one shot pulse osp is H level, the rising edge pulse rep occurs. In short, the zero current detection signal zcd rises again within the release time Trel. Therefore, at time t23, the reset signal rst occurs. As a result, at time t23, the power mode determination signal pmd switches from H level to L level. Thus, the ultralow power mode of the semiconductor device itself is released.

Next, referring to FIG. 9, an operation of the semiconductor device according to the second embodiment will be described. FIG. 9 is a timing chart for explaining an operation of the semiconductor device according to the second embodiment.

From the top to the bottom in FIG. 9, the zero current detection signal zcd, the output voltage Vout, the inductor current IL, the switching node voltage Vsw, the set signal set, the reset signal rst, the power mode determination signal pmd, and the clock signal clk are shown. In FIG. 9, time indicated by the same sign in FIGS. 4 and 8 is identical with that in FIGS. 4 and 8.

The timing chart during the period between time t1 and time t4 is identical with that in FIG. 4, so the description thereof is omitted.

Between time t4 and time t6, at time t5 when the predetermined detection time Tdet elapses from the rising edge (time t4) of the zero current detection signal zcd, the set signal set switches from L level to H level. As a result, the power mode determination signal pmd switches from L level to H level. In other words, the first power mode determination unit PMD1 determines that the microcomputer is in the ultralow power mode.

Note that, as shown in FIG. 5, the set signal set is generated from the output signal of the AND gate AND1. The zero current detection signal zcd and the inverted signal of the power mode determination signal pmd are input to the AND gate AND1. Therefore, when the set signal set rises and the power mode determination signal pmd also rises, the set signal set soon falls.

As shown in FIG. 4, in the semiconductor device according to the first embodiment, when the zero current detection signal zcd falls at time t6, the power mode determination signal pmd switches from H level to L level. Thus, the ultralow power mode of the semiconductor device itself is released. As shown in FIG. 9, in the semiconductor device according to the second embodiment, since the power mode determination signal pmd is maintained at H level, the ultralow power mode of the semiconductor device itself is also maintained.

As described with reference to FIG. 8, when the zero current detection signal zcd rises at time t8, the second power mode determination unit PMD2 determines whether the zero current detection signal zcd rises again within the release time Trel by time t21. As shown in FIG. 9, since the zero current detection signal zcd does not rise within the release time Trel, no reset signal rst occurs. Therefore, the power mode determination signal pmd is maintained at H level and the ultralow power mode of the semiconductor device itself is also maintained.

As shown in FIG. 4, in the semiconductor device according to the first embodiment, when the zero current detection signal zcd rises at time t10, the power mode determination signal pmd switches from H level to L level. As shown in FIG. 9, in the semiconductor device according to the second embodiment, the power mode determination signal pmd is maintained at H level.

As described with reference to FIG. 8, when the zero current detection signal zcd rises at time t11, the second power mode determination unit PMD2 determines whether the zero current detection signal zcd rises again within the release time Trel by time t24. Here, between time t10 and time t11, the microcomputer changes from the ultralow power mode to the low power mode. Therefore, the period during which the zero current detection signal zcd is H level is short and the frequency of its rising increases. As shown in FIG. 9, at time t23 in the release time Trel, the zero current detection signal zcd rises again. Therefore, at time t23, the reset signal rst occurs. As a result, the power mode determination signal pmd switches from H level to L level. Thus, the ultralow power mode of the semiconductor device itself is released.

As described above, in the semiconductor device according to the first embodiment, each time the zero current detection signal zcd falls, the ultralow power mode of the semiconductor device itself is released even though the microcomputer is in the ultralow power mode. In the semiconductor device according to the second embodiment, while the microcomputer is in the ultralow power mode, the semiconductor device itself can maintain the ultralow power mode. Therefore, it is possible to reduce power consumption of the semiconductor device.

While the invention has been described in terms of several embodiments, those skilled in the art will recognize that the invention can be practiced with various modifications within the spirit and scope of the appended claims and the invention is not limited to the examples described above.

What is claimed is:

1. A semiconductor device comprising:
first and second switching elements connected in series through a switching node;
a pulse control unit that pulse-controls switching operations of the first and the second switching elements;
an inductor that outputs an output voltage from a second end, a first end of the inductor being coupled to the switching node;
a detection unit that detects that an inductor current flowing through the inductor is zero; and
a first determination unit that determines that an operation mode of an external circuit to which the output voltage is supplied is a second mode when a period during which the inductor current is zero is longer than a first reference period, a power consumption in the second mode being smaller than that in a first mode.

2. The semiconductor device according to claim 1, wherein the detection unit detects that the inductor current is zero by measuring a voltage of the switching node.

3. The semiconductor device according to claim 1, wherein the pulse control unit turns off the second switching element at a timing when the inductor current becomes zero.

4. The semiconductor device according to claim 1, further comprising:
a second determination unit that determines that the operation mode of the external circuit is the first mode when a frequency with which the inductor current becomes zero exceeds a reference frequency.

5. The semiconductor device according to claim 4, wherein the second determination unit determines that the operation mode of the external circuit is the first mode when the inductor current becomes zero again within a second reference period after the inductor current becomes zero.

6. The semiconductor device according to claim 4,
wherein while the operation mode of the external circuit is determined to be the first mode, the first determination unit operates and the second determination unit stops, and
wherein while the operation mode of the external circuit is determined to be the second mode, the first determination unit stops and the second determination unit operates.

7. The semiconductor device according to claim 1, wherein when the operation mode of the external circuit is determined to be the second mode, the pulse control unit reduces a power consumption of the pulse control unit itself below that when the operation mode of the external circuit is determined to be the first mode.

8. A control method of a semiconductor device comprising:
detecting that an inductor current flowing through an inductor is zero, a first end of the inductor being coupled to a switching node between first and second switching elements connected in series, and an output voltage being output from a second end of the inductor; and
determining that an operation mode of an external circuit to which the output voltage is supplied is a second mode when a period during which the inductor current is zero is longer than a first reference period, a power consumption in the second mode being smaller than that in a first mode.

9. The control method of a semiconductor device according to claim 8, wherein the inductor current is detected to be zero by measuring a voltage of the switching node.

10. The control method of a semiconductor device according to claim 8, wherein the second switching element is turned off at a timing when the inductor current becomes zero.

11. The control method of a semiconductor device according to claim 8, wherein the operation mode of the external circuit is determined to be the first mode when a frequency with which the inductor current becomes zero exceeds a reference frequency.

12. The control method of a semiconductor device according to claim 11, wherein the operation mode of the external circuit is determined to be the first mode when the inductor current becomes zero again within a second reference period after the inductor current becomes zero.

13. The control method of a semiconductor device according to claim 8, wherein when the operation mode of the external circuit is determined to be the second mode, a power consumption of the semiconductor device itself is reduced below that when the operation mode of the external circuit is determined to be the first mode.
